(19) United States
(12) Patent Application Publication
(10) Pub. No.: US 2025/0151712 A1
(43) Pub. Date: May 15, 2025

(54) FILM PRODUCT FOR APPLICATION TO A BUILDING SHELL FOR PROTECTION AGAINST BIRD IMPACT

(71) Applicant: BirdShades Innovations GmbH, Leoben (AT)

(72) Inventors: Christoph CERNY, Leoben (AT); Dominique WADDOUP, Leoben (AT)

(73) Assignee: BirdShades Innovations GmbH, Leoben (AT)

(21) Appl. No.: 18/835,359

(22) PCT Filed: Feb. 2, 2023
(86) PCT No.: PCT/AT2023/060029

§ 371 Date: Aug. 2, 2024

(30) Foreign Application Priority Data
Feb. 3, 2022 (AT) A39/2022

(51) Int. Cl. A01M 29/08

(52) U.S. Cl. CPC A01M 29/08

(57) ABSTRACT

The present invention relates to a film product (10) for application to a building envelope (200), in particular a transparent section of the building envelope (200), for protection against bird strikes, having a film body (20) with a planar extension, wherein the film body (20) has at least one UV bird protection section (30) with an optical effect in the UV range (UV) as a UV bird protection function and at least one VIS bird protection section (40) with an optical effect in the VIS range (VIS) visible to humans as a VIS bird protection function.

The present invention relates to a film product for application to a building envelope for protection against bird strikes, a façade element having such a film product and a manufacturing method for manufacturing such a film product.

It is known that large glass façades and window surfaces on buildings need to be protected against bird strikes. A bird strike is to be understood as a situation in which a bird does not perceive a window or glass surface on a building as an obstacle and flies into it. This can happen if, due to reflections of the environment, the bird does not recognise the glass pane as a barrier, but chooses it as a flight path. In such a case, damage to the glass pane is possible, but injuries to the birds in particular are the undesirable consequence.

In order to achieve a bird protection function on such glass surfaces, it is already known to cover this glass surface with visible bird patterns. It is also known for protective films with an effect in the UV range to be used to provide a bird protection function which provide optical patterns effective in the UV range.

The known solutions have significant disadvantages. The stickers that are effective in the visible range are not desirable for visual and aesthetic reasons. In particular, they mean that people can no longer see from the interior to the outside through this glass surface, and the visible bird protection stickers represent a visual obstacle. The protection that is effective in the UV range, which is only effective in the UV range, cannot be perceived by humans. This means that proof of an existing bird protection function in a partial section of a building envelope cannot be verified optically.

It is the object of the present invention to remedy, at least in part, the disadvantages described above. In particular, it is the object of the present invention to combine improved protection for birds against bird strikes with aesthetic advantages for humans in a cost-effective and simple way.

The above object is achieved by a film product with the features of claim 1, a façade element with the features of claim 13 and a manufacturing method with the features of claim 14. Further features and details of the invention are disclosed in the dependent claims, the description and the drawings. Naturally, features and details described in connection with the film product according to the invention also apply in connection with the façade element according to the invention as well as the manufacturing method according to the invention and vice versa, so that, with regard to disclosure, mutual reference is or can always be made to the individual aspects of the invention.

According to the invention, a film product is designed for application to a building envelope, in particular a transparent partial section of the building envelope. This film product serves to provide protection against bird strikes and has a film body with a planar extension. This film body is equipped with at least one UV bird protection section with an optical effect in the UV range as a UV bird protection function. The film body also has at least one VIS bird protection section with an optical effect in the VIS range visible to humans as a VIS bird protection function.

A building envelope can be understood as any type of material, in particular those that are reflective and/or transparent. These can for example be glass surfaces, plastic surfaces and/or metal surfaces.

The film product can be applied to the surface of the building envelope and/or embedded in the material of the building envelope. For example, a multi-layered material is conceivable in which the film product, in particular a film body of the film product, forms one or more of the layers. Formation together with the material of the building envelope, for example by co-extrusion, is also conceivable here.

A film product in the sense of the present application may take different forms. For example, a multi-layered design for the film body is conceivable. However, simpler, in particular single-layer film bodies are also possible. Of course, a more complex design with different partial sections which adjoin each other is also to be understood as a film product in the sense of the present invention.

The core idea according to the invention is fundamentally based on the possibility of providing a UV bird protection function in the UV range. For this purpose, the film body is equipped with at least one UV bird protection section. This ensures the UV bird protection function. For example, it is possible that the UV bird protection section has corresponding geometric shapes which, in the form of one or more UV bird protection sections, create a UV pattern which is perceived by birds but not by humans. For example, this can be a grid pattern, a mesh pattern and/or other pattern shapes which are not perceptible to humans but are perceptible to the bird in the UV range, are recognised as an obstacle, and in this way fulfil a bird protection function.

The core idea according to the invention now additionally complements this UV bird protection function with a VIS bird protection function. The VIS bird protection function is ensured by the VIS bird protection section, which has a visual effect in the VIS range. Similarly to the UV bird protection function, the optical effect is a particular degree of reflection, absorption and/or transmission which produces the optical effect due to a different design compared to the optical effect of the glass pane of the building envelope.

For example, it is possible that, to achieve the UV bird protection function, the UV bird protection section results in an increased absorption or increased reflection and thus a reduced or increased reflection in the UV range compared to glass. As a result, the UV bird protection section is perceived by birds as being darker or lighter than the surrounding pure glass areas without a bird protection section. Similarly, it is also possible that the VIS bird protection function in the VIS bird protection section is achieved by a corresponding optical effect in correlation with the glass. For example, increased reflection, in particular in a coloured part of the VIS range, can result in an additional bird protection function as a VIS bird protection function.

Particularly if the VIS bird protection section is to be effective independently of its geometric shape, for example through the full-surface application on the film body which will be explained later, the combined function can be explained as follows. In contrast to a pure UV bird protection, the combined functionality of the film product means that the VIS bird protection section in the visible VIS range changes the bird's perception of the background. For example, the bird perceives the backgrounds in a different colour than they would appear in the natural colour range. This change already indicates to the bird in a first step that this may not be a possible flight path. In combination with the UV bird protection section, this means that, against the changed background of the VIS bird protection section, a barrier function can now also be achieved for the bird in the UV range.

According to the invention, the optical effect in the UV range and the optical effect in the VIS range are thus combined, so that in total an increased protective functionality and thus an increased bird protection effect can be achieved by the film product as an overall bird protection function.

A further advantage of the design according to the invention is that the VIS bird protection section not only provides its bird protection function through its visibility for the bird, but in addition also lies in the VIS range visible to humans. This makes it possible to make the bird protection function visually recognisable to humans in that they only perceive the VIS bird protection section. While the UV bird protection section primarily fulfils the corresponding barrier function for the bird through its design, the VIS bird protection section can provide the background function for the bird, as already explained. As a result, the VIS bird protection section in particular, as will be explained later, has a planar, in particular full-surface extension on the film product. Compared to the known visible patterns, for example adhesive black bird silhouettes, the advantage can be achieved here that no impairment of the visual axis occurs, as in the known manner. Rather, the VIS bird protection section in particular will have a minimum transparency, so that it does not result in any impairment for humans either through a specific design or through a complete lack of transparency.

It can thus be summarised that the film product provides a broader protection functionality against bird strikes through the combination of two bird protection functions. At the same time, this increase in protective functionality leads to an improved and more pleasant aesthetic perception for humans.

The respective optical effect is achieved in particular by dyes, pigments, metallic mirrored sections or the like in the film body. These can for example be effect pigments and/or interference pigments. As already explained, the respective optical effect in the UV range and in the VIS range is provided by the difference in relation to the substrate, i.e. by the difference in relation to the glass material of the transparent partial sections of the building envelope.

It can bring advantages if, in a film product according to the invention, the at least one VIS bird protection section in the VIS range visible to humans is at least partially transparent, in particular having a transmittance of at least 50%. Higher transmittances in the VIS range of about 80% or more are preferred. This is possible because the VIS bird section does not serve to provide the bird protection function on its own, but rather merely supplements the already fundamentally effective bird protection provided by the UV bird protection function. Thus, the degree of bird protection function provided by the VIS bird protection section is no longer decisive, as would be the case with a VIS bird protection section alone. This allows greater freedom in the design of the VIS bird protection section. In particular, in addition to free design possibilities, the highest possible degree of transmission can be selected, so that as much brightness as possible reaches the interior of the building through the glass pane of the building envelope in the VIS range. This avoids a complete blocking, so that on the one hand a high level of brightness can be achieved within the building envelope. In addition, a blocking is avoided, which also makes it particularly easy to see through the glass pane of the building envelope, preferably in both directions. In this way, an unpleasant effect on humans caused by frosted glass, darkening or shading is thus avoided in a particularly advantageous manner.

In addition, it can be advantageous if, in a film product according to the invention, the at least one VIS bird protection section only has the optical effect in a VIS sub-range of the VIS range visible to humans. The VIS range and also the UV range are parts of a light spectrum. The UV range usually ends in the range of about 390 to 420 nanometres, while the VIS range starts at about 390 to 420 nanometres. It is preferable if the UV bird protection function achieves at least a partial effect in the UV range. This means that it can also achieve a partial effect in the VIS range, for example if it is in the transition range of around 390 to 420 nanometres. The VIS range covers all visible white light and therefore ranges from the blue spectrum to the wavelength of the red spectrum. In this embodiment of a film product according to the invention, the optical effect is limited to a VIS sub-range. This means that the difference, for example in reflectivity, between glass and the VIS bird protection section only exists in a VIS sub-range, while outside of this VIS sub-range, the VIS bird protection section corresponds or substantially corresponds in its optical effect to the optical effect of glass. The limitation can for example be applied to different colour ranges or to exactly one colour range, so that the VIS bird protection function is only provided in a narrow frequency band as VIS sub-range within the visible VIS range. This will in particular bring advantages since the effect on humans will be even more pleasant if, in particular in relation to wavelengths that are pleasant for humans, wavelengths perceived as unpleasant are correlated with the VIS sub-range and so to speak filtered out by this by reflection. The bird protection function in the VIS range is thus combined with an even further increase in comfort for humans when the film product is applied to a transparent building envelope.

It can also be advantageous if, in a film product according to the invention, the at least one VIS bird protection section is formed over the entire surface or substantially over the entire surface. A full-surface design results in a background function for the bird, since the background changes for the bird in its perception of the film product. The planar extension also has the advantage that this function is reduced in its effect on humans, since they no longer perceive any differences in shape or contrast in the VIS range. Rather, a good supplementary effect for birds is combined here with a more pleasant perception for humans. Of course, patterns, in particular geometric shapes, are also in principle possible for the at least one VIS bird protection section which are for example complementary or identical to the shapes of the UV bird protection section.

A further advantage can be achieved if, in a film product according to the invention, the geometric extent of the at least one VIS bird protection section corresponds to or substantially corresponds to the geometric extent of the UV bird protection section. In particular, the VIS bird protection section and UV bird protection section overlap or are completely identical to each other. The VIS bird protection section and the UV bird protection section are for example completely or substantially completely superimposed on each other. On the one hand, this means that the combination of VIS bird protection section and UV bird protection section can preferably be made available in a common layer, in particular actually formed by a common pigment mixture or a mixture of other materials, as already mentioned. In addition, in this way the reproduction of the VIS bird protection section for the UV bird protection section makes this visible, since the same shape and presence can be perceived by humans on the basis of the VIS bird protection section.

It is also advantageous if, in a film product according to the invention, the at least one UV bird protection section and the at least one VIS bird protection section are arranged in relation to each other without overlapping or substantially without overlapping, in particular directly or substantially directly adjacent to each other. Stripe patterns are therefore preferably arranged next to each other, so that the combined effect for birds is provided in a complementary way between the UV protection function and the VIS bird protection function. The combination effect is even more pronounced than the sum of the individual effects in the UV range and the VIS range.

It can also bring advantages if, in a film product according to the invention, the at least one UV bird protection section and the at least one VIS bird protection section are at least partially arranged in a common film layer of the film body. This is in particular possible if a common pigment mixture can be used for both bird protection functions. It allows separate functional principles in a common film layer and thus a joint provision of a film protection functionality. The arrangement in the same layer means that the number of film layers for the film body can preferably also be reduced.

It can bring further advantages if, in a film product according to the invention, the at least one VIS bird protection section is formed in the blue VIS sub-range and/or in the red VIS sub-range. These two VIS sub-ranges are also to be regarded as biological signal colours which have a corresponding signalling effect on birds. Particularly if the VIS bird protection section does not provide its own formative protective function but, as already explained, creates the protective function as background functionality, the application in VIS sub-ranges with increased biological signalling is advantageous.

In addition, it brings advantages if, in a film product according to the invention, the at least one UV bird protection section has an optical effect in the UVA sub-range of the UV range. Of course, combinations with other UV sub-ranges are also conceivable. For example, UV bird protection sections with different optical effects in different UV sub-ranges are conceivable. However, the UVA sub-range is to be regarded as the most visible and therefore most effective UV sub-range of the UV range for a large number of birds.

In addition, it is advantageous if, in a film product according to the invention, at least two UV bird protection sections are formed with a defined geometric shape to create and/or support the bird protection function. Such a geometric shape can for example be a grid or a raster in the UV range. The shape is to be understood in particular as gap widths or stripe widths with gaps between the individual stripes. This is preferably applied to an embodiment with two or significantly more UV bird protection sections.

In addition, it is advantageous if, in a film product according to the invention, the film body has at least one marking in the VIS range visible to humans. This can be part of the VIS bird protection section or can be formed separately from it. For example, the marking can be part of a logo or verification information such as a seal. For example, it forms a kind of watermark which makes it possible to make the presence of the film product on a building envelope easily and quickly visible to humans. This thus provides an additional function for humans.

A further subject matter of the present invention is a façade element for a partial section of a building envelope, in particular in the form of a window or a glass element. Such a façade element has a main façade body which is equipped with a film product according to the present invention. Thus, a façade element according to the invention brings the same advantages as have been explained in detail with reference to a film product according to the invention. The film product can be integrated into the manufacturing process of the façade element and can for example be integrated between different glass layers or glass panes of the façade element. It is also possible that the façade element has been coated with the film product subsequently, i.e. the film product is formed on the façade element by means of a coating process. Last but not least, application by adhesion is also conceivable, for example a rolled-up film product with an adhesive layer which is unrolled and applied to the façade element in an adhesive manner.

In addition, the subject matter of the present invention includes a manufacturing method for manufacturing a film product according to the invention, comprising the following step:
Forming a film body with at least one functional layer, having at least one UV bird protection section with an optical effect in the UV range as a UV bird protection function and at least one VIS bird protection section with an optical effect in the VIS range visible to humans as a VIS bird protection function.

Further advantages, features and details of the invention are explained in the following description, in which exemplary embodiments of the invention are described in detail with reference to the drawings. The features mentioned in the claims and in the description may in each case be essential to the invention individually or in any combination. In each case schematically:

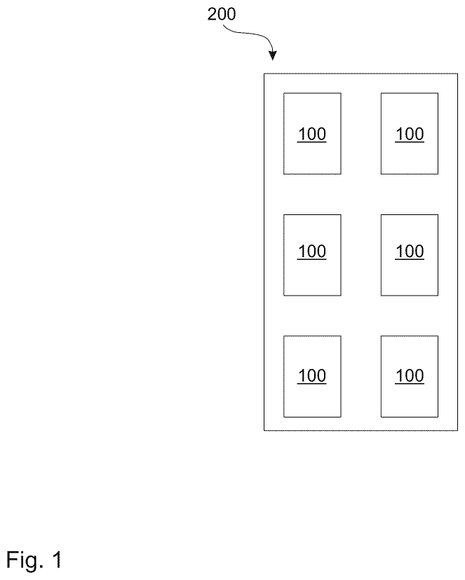

FIG. 1 shows an application on a building envelope,

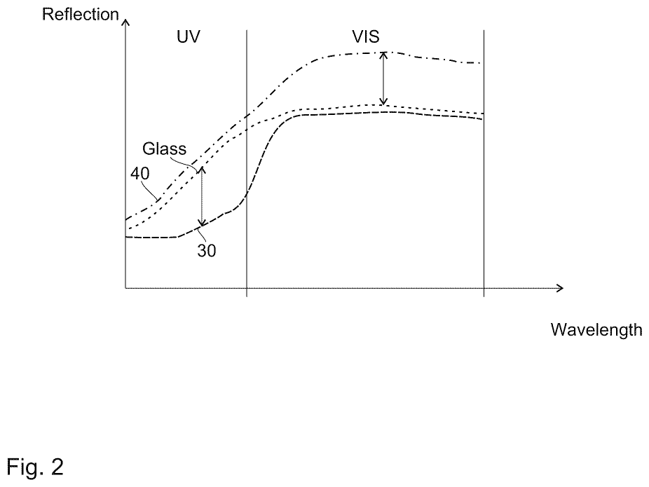

FIG. 2 shows a spectrum analysis for a film product according to the invention,

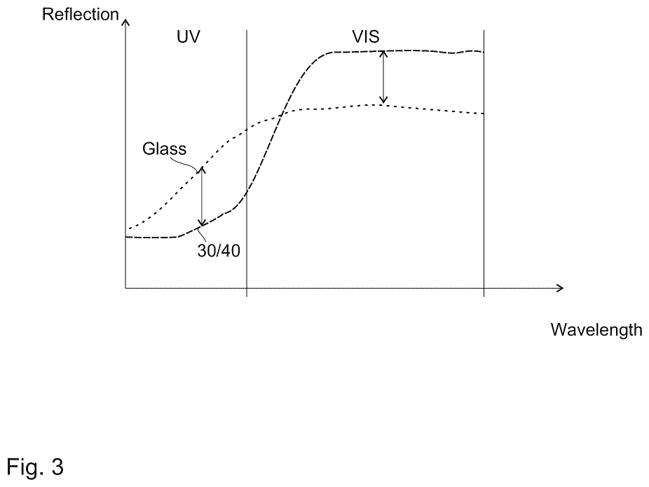

FIG. 3 shows a further spectrum analysis for a film product according to the invention,

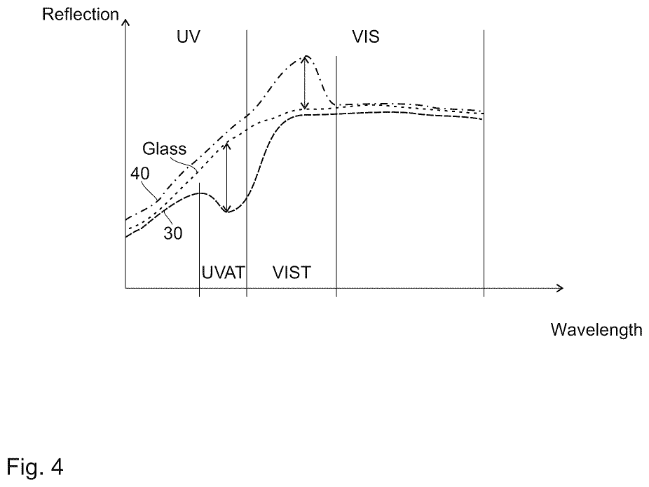

FIG. 4 shows a further spectrum analysis for a film product according to the invention,

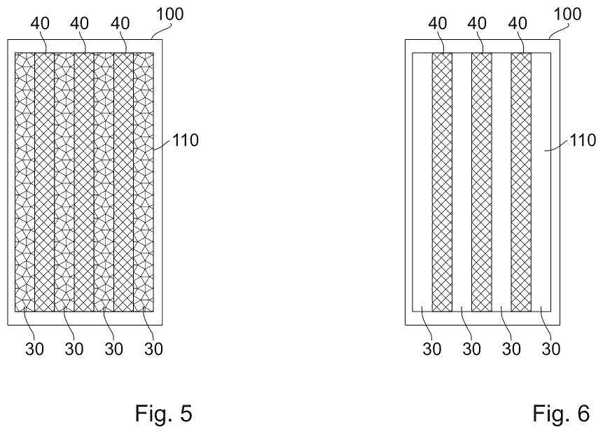

FIG. 5 shows a film product according to the invention from the point of view of a bird,

FIG. 6 shows the film product of FIG. 5 from the point of view of a human,

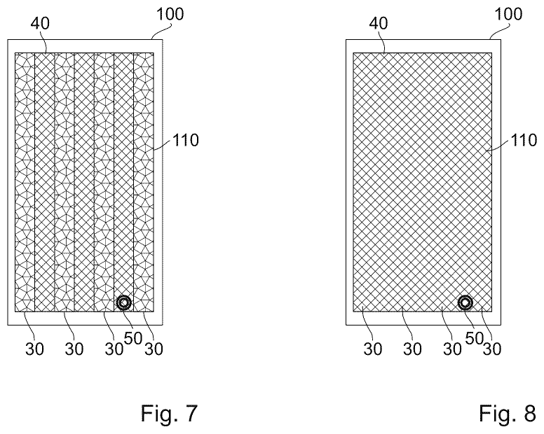

FIG. 7 shows a further film product according to the invention from the point of view of the bird,

FIG. 8 shows the film product of FIG. 7 from the point of view of a human,

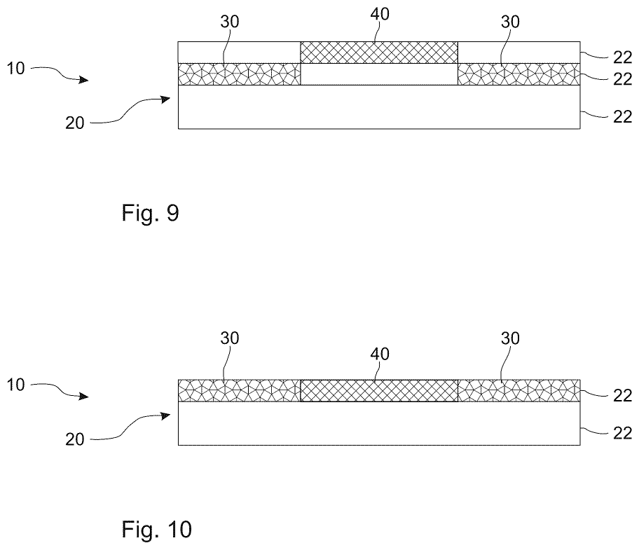

FIG. 9 shows a cross-section of a possible film product,

FIG. 10 shows a cross-section of a further possible film product,

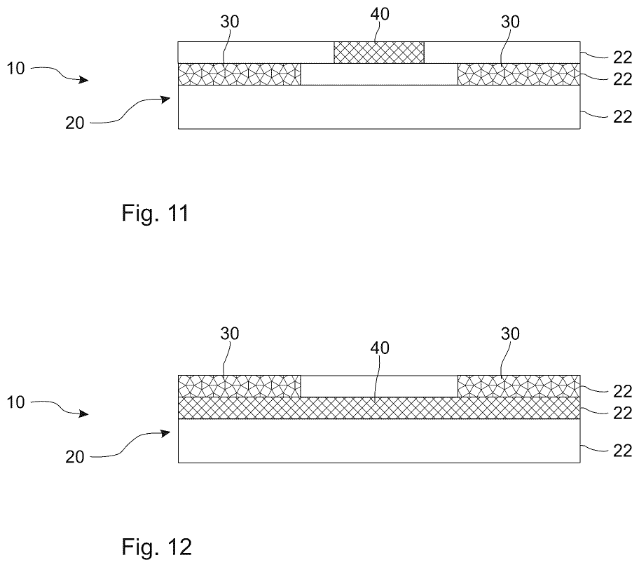

FIG. 11 shows a cross-section of a further possible film product and

FIG. 12 shows a cross-section of a further possible film product.

FIG. 1 shows in highly schematic form an area of application for a film product 10 according to the invention. A building envelope 200 in the form of a three-storey building can be seen here, with two façade elements 100 in the form of windows arranged on each floor in the orientation shown in FIG. 1. These can be glass panes or mirrored windows that form the façade elements 100. In this arrangement, there is a risk that birds will not perceive these façade elements 100 in the form of windows as an obstacle and accordingly a bird strike will occur if birds fly at full speed into these façade elements 100. To avoid this, the façade elements 100 can now be equipped on their main façade body 110 with film products 10, as shown in FIGS. 5 to 12 for example.

The functional effect of a film product 10 according to the present invention is explained in FIG. 2 with reference to an example. Here, a spectrum is plotted and the functional effect of three different materials is represented. The normal dotted line shows the reflective effect of glass. There is a higher reflection in the VIS range than in the UV range, so that the bird clearly recognises this as glass, since there is a higher reflection in the VIS range and a decreasing reflection in the UV range. A film product 10 with a UV bird protection section 30 can be formed on such a glass pane. This UV bird protection section 30 has a different spectrum characteristic than glass, for example due to the selection of the appropriate effect pigments. This is indicated in FIG. 2 by the second line with the longer dashes. In contrast to glass, a significantly lower reflection can be seen here in the UV range, which means that the areas coated with the UV bird protection section 30 are perceived by the bird in the UV range as being significantly darker, as they reflect UV light less than glass. In the VIS range, there is no difference or only a very small difference between the UV bird protection section 30 and glass in this embodiment. Thus, the UV bird protection section 30, due to the difference in the UV range to the curve for glass, shown here by the double arrow, produces the aforementioned optical effect in the UV range, so that the corresponding UV bird protection function is guaranteed.

FIG. 2 also shows the spectral functional effect of the VIS bird protection section 40. This runs in the UV range along the dotted curve for glass and is represented by a dot-dashed line. In the VIS range, however, the spectral effect of the VIS bird protection section 40 continues to increase, and above all exceeds the reflection of glass. Here again, the difference in reflection in the VIS range between the VIS bird protection section 40 and glass is shown with a double arrow, so that in this case the optical effect in the VIS range now provides the VIS bird protection function.

FIG. 3 shows a variant in which, for example integrated into a common film layer 22 and in particular with a common pigment mixture, the UV bird protection section 30 and the VIS bird protection section 40 are formed together, so to speak. This means that the two curves, which are still separate in FIG. 2, combine to form a common curve which now provides the desired optical effects in both the UV range and the VIS range, represented by the double arrows in contrast to the spectral effect of glass. This simplifies effort and production, as the combination effect can be formed by a common pigment mixture, for example in a common film layer 22.

FIG. 4 shows another further development of the embodiment of FIG. 2. Here, the UV bird protection section 30 is provided with a modified pigment mixture, so that the difference in the UV range is limited to a UVA sub-range UVAT. The VIS bird protection section 40 is also limited to a VIS sub-range VIST, in this case in the blue spectral range of the VIS range. In the other UV ranges and VIS ranges, separate from the UVA sub-range UVAT and VIS sub-range VIST, the spectral effect curves of the UV bird protection section 30 and VIS bird protection section 40 again run substantially along the spectral effect of glass. This limitation means that an equal or even improved combination effect for the bird can be combined with an even simpler and more pleasant effect for humans, especially in relation to the VIS range.

FIGS. 5 and 6 show how a film product 10 has different effects on humans and birds. FIG. 5, for example, shows the bird's perception. The façade element 100 is formed here with a main façade body 110 on which a film product 10 of the present invention is arranged. This film product 10 is designed here with a total of three stripe-shaped VIS bird protection sections 40 and four complementary stripe-shaped UV bird protection sections 30. Thus, a double stripe pattern is formed, which the bird perceives. This double stripe pattern is perceived by the bird, with its different spectrum of perception compared to that of humans, as shown in FIG. 5. FIG. 6, in contrast, shows how the same film product 10 from FIG. 5 is perceived by humans. Since humans are not able to see in the UV range, this means that the reflection effects differing from those of glass, as explained for example in FIGS. 2, 3 and 4, are not recognisable to humans in the UV bird protection sections 30. These thus recede and are not visible; only the effect of the glass of the façade element 100 is perceived. However, the optical effect of VIS bird protection sections 40 effective in the VIS range is manifested in the VIS range visible to humans, so that the stripe pattern is accordingly recognisable. The stripe pattern is preferably transparent, so that while it is perceived it is not experienced as obtrusive by humans.

FIGS. 7 and 8 show a further development of the embodiment of FIGS. 5 and 6. Here, it is easy to see that the VIS bird protection section 40 is no longer stripe-shaped, but arranged over the entire surface. It thus forms a background function for the bird, which in FIG. 7 is substantially identical to the embodiment of FIG. 5. For humans, however, this full-surface design leads to a more noticeably pleasant perception, since even with an identical optical effect, the perception of the VIS bird protection section 40 recedes due to the lack of geometric contrast on the façade element 100. In contrast, as shown in FIG. 7 the UV bird protection sections 30 create, for the bird, the same contrasting effect to the background of the VIS bird protection section 40 as described for FIG. 5.

In addition, in the embodiment shown in FIGS. 7 and 8, a marking 50 is also arranged in the VIS range, which allows the bird protection function to be made visible to humans easily and quickly in the form of a seal or a logo.

FIGS. 9 to 12 show variants in the layer structure of the film body 20. FIG. 9 shows a multi-layer structure, wherein two optical functional layers are arranged as film layers 22 on a carrier layer or a multi-layer carrier layer as film layer 22. The geometric extent of the again stripe-shaped formation of the UV bird protection sections 30 and the VIS bird protection section 40 is here complementary to each other, whereby filling layers above and below the respective functional layers complement the film layers 22. An identical optical effect can be achieved, as shown in FIG. 10, by integrating the UV bird protection sections 30 and the VIS bird protection section 40 into a common film layer 22.

FIG. 11 shows another variant with a non-overlapping and non-complementary design of the individual bird protection sections 30 and 40. FIG. 12 shows a full-surface variant, as has also been explained, for example, in FIGS. 7 and 8. Here, the background function of the VIS bird protection section 40 serves to bring the described advantages for humans and in this case is arranged particularly easily in the inner film layer 22, for example by a co-extrusion process.

The above explanation of the embodiments describes the present invention exclusively in the context of examples. Of course, individual features of the embodiments can be freely combined with each other, where technically expedient, without departing from the scope of the present invention.

### LIST OF REFERENCE SIGNS

10 film product
20 film body
22 film layer
30 UV bird protection section
40 VIS bird protection section
50 marking
100 façade element
110 main façade body
200 building envelope
UV UV range
UVAT UVA sub-range
VIS VIS range
VIST VIS sub-range

1. Film product for application to a building envelope, in particular a transparent section of the building envelope, for protection against bird strikes, having a film body with a planar extension, wherein the film body has at least one UV bird protection section with an optical effect in the UV range (UV) as a UV bird protection function and at least one VIS bird protection section with an optical effect in the VIS range (VIS) visible to humans as a VIS bird protection function.

2. Film product according to claim 1, wherein the at least one VIS bird protection section in the VIS range (VIS) visible to humans is at least partially transparent, in particular having a transmittance of at least 50%.

3. Film product according to claim 1, wherein the at least one VIS bird protection section only has the optical effect in a VIS sub-range (VIST) of the VIS range (VIS) visible to humans.

4. Film product according to claim 1, wherein the at least one VIS bird protection section is formed over the entire surface or substantially over the entire surface.

5. Film product according to claim 1, wherein the geometric extent of the at least one VIS bird protection section corresponds to or substantially corresponds to the geometric extent of the UV bird protection section.

6. Film product according to claim 1, wherein the at least one UV bird protection section is at least partially arranged in a different film layer of the film body than the at least one VIS bird protection section.

7. Film product according to claim 1, wherein the at least one UV bird protection section and the at least one VIS bird protection section are arranged in relation to each other without overlapping or substantially without overlapping, in particular directly or substantially directly adjacent to each other.

8. Film product according to claim 1, wherein the at least one UV bird protection section and the at least one VIS bird protection section are at least partly arranged in a common film layer of the film body.

9. Film product according to claim 1, wherein the at least one VIS bird protection section is formed in the blue VIS sub-range (VIST) and/or in the red VIS sub-range (VIST).

10. Film product according to claim 1, wherein the at least one UV bird protection section has an optical effect in the UVA sub-range (UVAT) of the UV range (UV).

11. Film product according to claim 1, wherein at least two UV bird protection sections are formed with a defined geometric shape to create and/or support the bird protection function.

12. Film product according to claim 1, wherein the film body has at least one marking in the VIS range (VIS) visible to humans.

13. Façade element for a partial section of a building envelope, in particular in the form of a window or a glass element, comprising a main façade body having a film product with the features of claim 1.

14. Manufacturing method for manufacturing a film product with the features of claim 1, comprising the following step:
Forming a film base body with at least one functional layer, having at least one UV bird protection section with an optical effect in the UV range (UV) as a UV bird protection function and at least one VIS bird protection section with an optical effect in the VIS range (VIS) visible to humans as a VIS bird protection function.
